(19) United States
(12) Patent Application Publication
(10) Pub. No.: US 2008/0253237 A1
(43) Pub. Date: Oct. 16, 2008

(54) Methods and Apparatus for Automatic Information Retrieval through Internet and Providing the Feedback to Service Providers

(75) Inventor: Yong Fu, San Ramon, CA (US)

Correspondence Address: Venture Pacific Law, PC, 5201 Great America Parkway, Suite 270, Santa Clara, CA, 95054, US

(73) Assignee: CASGLE, LLC, San Ramon, CA (US)

(21) Appl. No.: 11/734,278

(22) Filed: Apr. 12, 2007

(51) Int. Cl. H04B 1/20

(52) U.S. Cl. 369/1; 710/303

(57) ABSTRACT

Apparatuses and methods for automatically downloading Information through Internet and providing the feedback to service provider are disclosed. The apparatus can contain an adaptor device and a portable device, can automatically download the online content, such as audio, video, etc, from the internet. The apparatus can also upload the voice mailbox and survey feedback automatically to content providers and provide the interactive communication between the subscribers and the content providers. A service system maintains a searchable program database that subscribers can choose their favorite programs from. The service system also maintains the subscriber's registration information, checks the audio/video program update, and directs the apparatus by sending it the new content list for download. The service system also collects/processes subscriber's feedback.

### CROSS REFERENCE

This application claims priority from a United States provisional patent application entitled “Apparatus and Method for automatically downloading information through internet and providing the feedback to service provider” filed on Apr. 11, 2006 having an application No.: 60/791,293. This application is incorporated herein by reference.

### FIELD OF INVENTION

This invention relates generally to the field of internet service and more particularly to methods and apparatuses for retrieving information through the internet and providing feedback to service providers.

### BACKGROUND OF THE INVENTION

Internet development and the wide adoption of broad band have introduced more and more new services. Media content providers are publishing more media content to the internet, such as online radio, IPTV, etc. XML standard enhanced the online information exchange method and RSS technology is further introduced as an easier approach for each individual to aggregate their own favorite programs. RSS technology leads to the birth of podcast technology which is to make the download of rich media content, such as audio and video easily, and to create time shifting, location shifting media consumption experience. Clients or subscribers first register the media program they like through computer aggregation software. Then whenever the computer is online, aggregation software checks if there are new episodes available from the registered program. If there are new content, the software downloads the new content to local hard disk. Subscribers then can play the downloaded content directly on computer. They can also synchronize the content to the portable devices such as IPOD, MP3 players, or cell phones and play on the go. iTune from Apple Computer Inc. is one of the most dominate computer software for podcast download. Other popular podcast softwares include Juice and Jpodder, etc. The issue with a computer based download methodology is, some content, especially audio programs are mainly consumed with portable media devices when subscribers are on the road, in the bed, or in the gym. To download content to the computer and then synchronize the content to portable media player such as a MP3 player is not convenient. The issue is not too critical for music download since usually a subscriber downloads songs once and plays for a fairly long time period. However, online media, such as podcast programs, are updated quite often. To follow the two steps download process daily for content update is quite painful. Research also shows that one of the top obstacles for online content download is the difficulty in content downloading.

With the concept of web 2.0, internet is focusing on community sharing. The content providers focus on improve the interactivity with their audiences and clients. When portable media player is used as the platform for play, interactivity between the content providers and subscribers is very limited. This does not fit well into the trend of the new online media.

As a whole, the existed technology that relies on a computer to download the content is feasible for list management but is burdensome for daily content update. Furthermore, the downloading of media content with portable devices does not provide interaction between the content provider and the content subscriber. Therefore, it is desirable to have methods and/or apparatuses for automatically downloading information including media content without a person computer and allows interactive communication between the content providers and content subscribers.

### SUMMARY OF THE INVENTION

An object of the invention is to provide systems and methods for retrieving online content from service providers' web site to the portable device through the internet without a personal computer. This would facilitate the daily updating of information and content.

Another object of the invention is to provide a feedback method to improve the capability of interactivity between the content provider and the consumer. The feedback method can improve the service quality and potentially be used for survey services, advertising, etc.

A further object of the invention is to provide a website base content management service. The service provides a web based interface for subscriber manage their favorite content list. The service also periodically checks the updated content and instructs the adaptor device to download the new content to portable media devices.

Other objects and advantages of the present invention will become apparent from the following descriptions, taken in connection with the accompanying drawings, wherein, by way of illustration and example, embodiments of the present invention are disclosed.

Briefly, in accordance with a preferred embodiment of the invention, there is disclosed an apparatus and method for automatically downloading information through internet and providing the feedback to service provider comprising, an apparatus that can automatically retrieve content, such as audio, video, etc., from the internet and can provide voice mailbox and feedback channel to enable the interactive communication between the subscribers and the service providers. In another embodiment, a service system that maintains a content list that subscriber can choose from when managing their own favorite content list. The service system also maintains the subscriber's registration information and downloading status related information, and collects/processes subscriber's feedback, either in audio format or in the special format for processing the returned survey results.

It is to be understood that the drawings are designed solely for the purpose of illustration and not as a definition of the limitation of the invention, for which reference should be made to the appended claims. It should also be understood that the drawings are not necessarily drawn to scale and that, unless otherwise indicated, they are merely intended to conceptually illustrate the structures and procedures described here in.

### DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrates a system architecture using the internet in accordance with an embodiment of the present invention.

FIG. 2 is a perspective view of an apparatus of in this invention.

FIG. 3 is a block diagram of a portable device that is an embodiment of the invention.

FIG. 4 is a block diagram of an adaptor device that is an embodiment of the invention.

FIG. 5 is a block diagram of software modules embedded inside a portable device that is an embodiment of the invention.

FIG. 6 is a flow chart of the operations that comprise a method for using the quick survey key and recording voice mail.

FIG. 7 is a block diagram of software modules inside an adaptor device that is an embodiment of the invention.

FIG. 8 is a flow chart of the operations comprising the method when the portable device is connected with the adaptor device.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

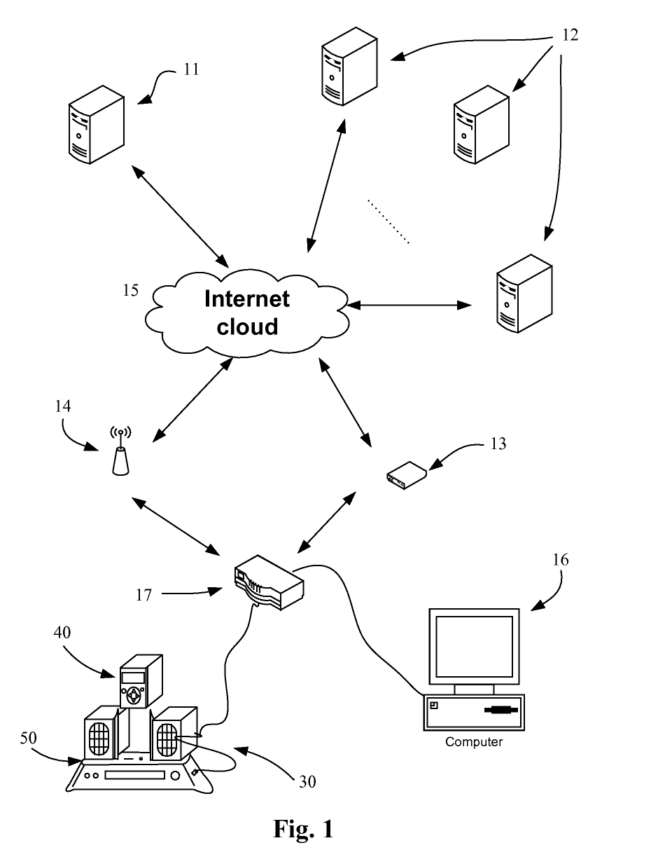

FIG. 1 illustrates an online system in accordance with an embodiment of the present invention. A management server 11 maintains the subscriber's information and maintains the content program list (a program may have one or more episodes). The content servers 12 are maintained by the content service providers. All the servers connect into internet cloud 15. On the subscriber's side, the apparatus 30 and subscriber's PC 16 usually connect to a hub or router 17. The router (or hub) 17 further connects to internet 15 through either wireless method 14, such as 802.11x or wired method 13, such as ADSL, cable modem. The apparatus 30 consists of an adaptor device 50 and a portable media playback device 40 (having playback functions and limited recording functions). Once the system is established, subscriber can use PC 16 to setup account in server 11, manage the content list for each portable media playback device 40. The content list will be saved inside server 11 so then the download can be done without the PC 16. The next time a portable media playback device 40 is plugged into the adaptor device 50, adaptor device 50 will communicate with management server 11. Server 11 checks if there is any new content for media player 40. If there is, server 11 will give a content list to adaptor device 50. Adaptor device 50 will download content from content server 12.

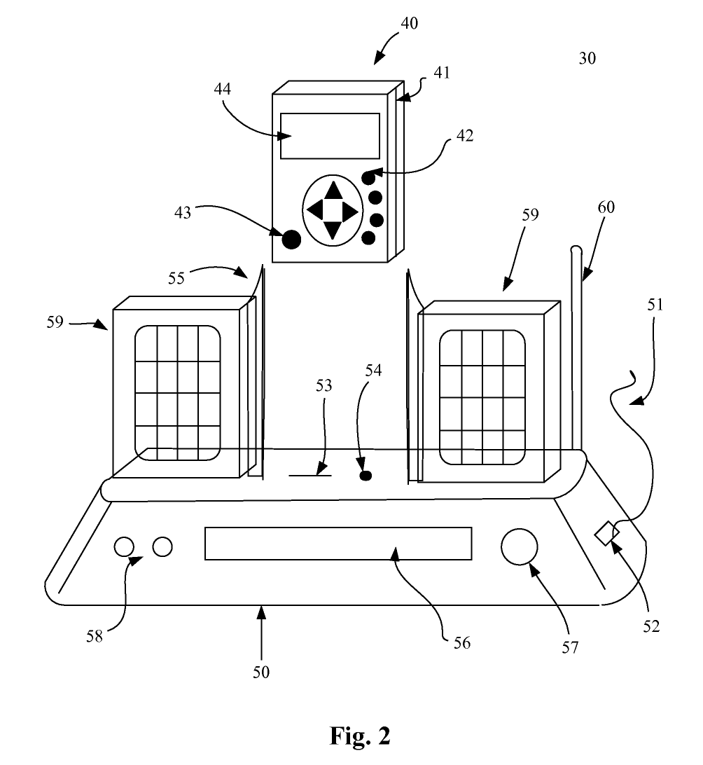

FIG. 2 is a perspective view of the apparatus 30 mentioned in this invention. The apparatus consists of physically two devices, the adaptor device 50 and the portable media playback device 40. The adaptor device 50 and the portable device 40 could be manufactured in one device as well. The adaptor device 50 has the wired internet connector 52 and/or the wireless connection 60. It contains two speakers 59 and also provides the connectors 58 to external audio system or speaker system. A LED display 56 is to show the current status of the adaptor device. A set of buttons 57 is used for further operation of the adaptor device 50 including a button to stop download. Once connected into internet, the adaptor device can communicate with management server 11 in a pre-defined interval to get the new content list. Device 50 can have local cache memory so it can download the new content from content server 12. The adaptor device has two tracks 55 so can lead the portable device 40 which has the slot 41 on each side to be plugged in easily and further protect the connectors 53 and 54.

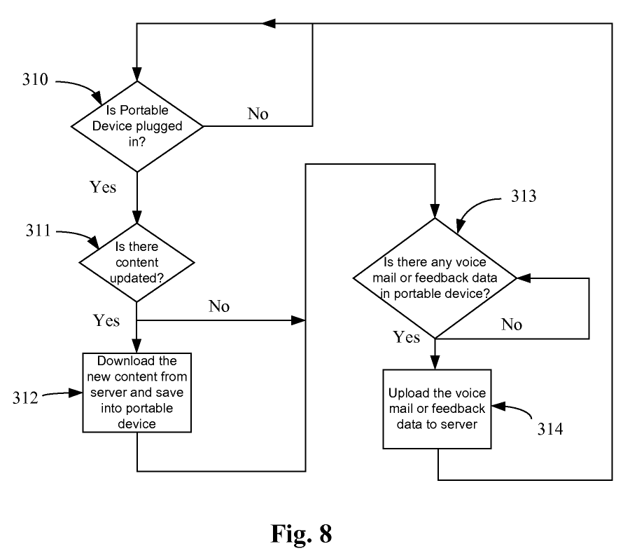

Once the portable device 40 is plugged in, the adaptor device starts a download procedure that will be addressed in FIG. 8. The portable device of present invention has a set of quick feedback buttons 42 and a record key 43. All these designs emphasize the ease use of recording subscriber's feedback.

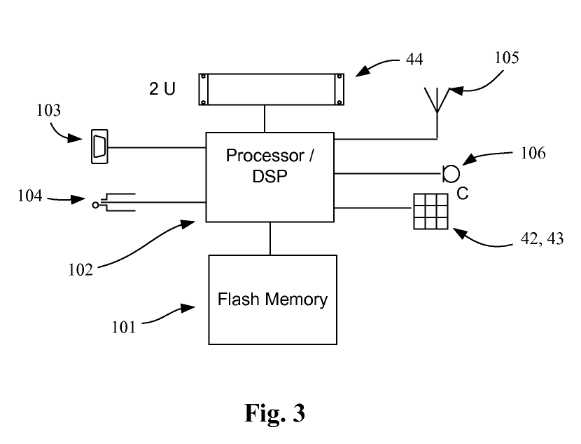

FIG. 3 is a block diagram of a portable device embodied in the invention. Besides All other components like the processor 102, flash memory 101, micro phone 106, antenna 105 is very common used now, this event defines several feedback buttons 42 and 43 in the patent. 42 are a set of buttons, physical or a touch screen button on a portable device, being used as the quick survey button. 43 is a record button. Most of the portable device does have record function, but unfortunately requires a lot of steps to start record. The device we define will have one button that can lead the portable device directly go into the record function.

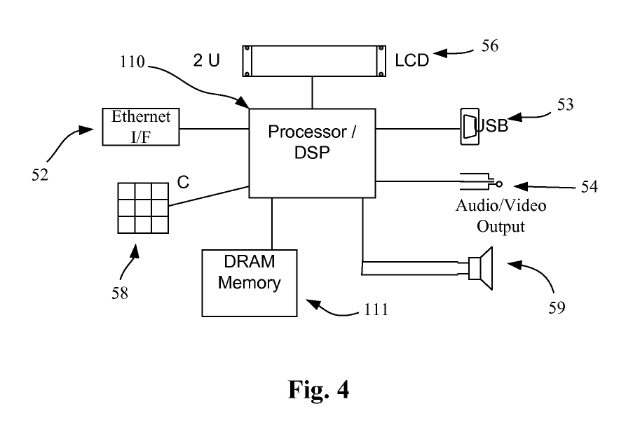

FIG. 4 is a block diagram of an adaptor device 40 embodied in the invention. Adaptor device 40 has internet interface 52 and USB interface 53. Audio/Video output can connect the external Speaker and television. Adaptor device 40 also can have a speaker 59 built into the device. Inside the adaptor device, there is a processor or Digital Signal Processor 110 that run software to control the network connection, content download tasks.

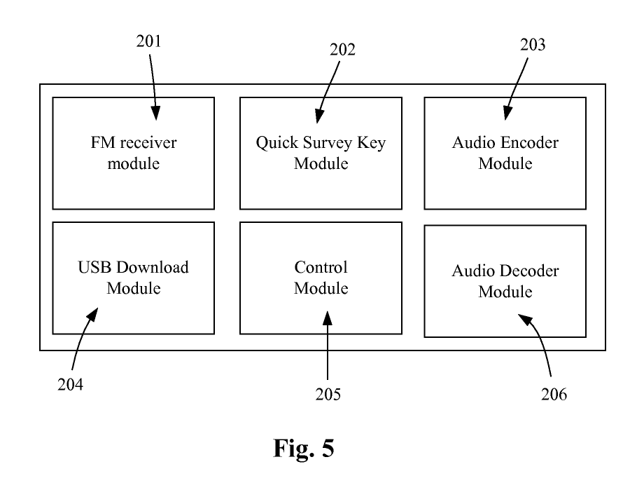

FIG. 5 is a block diagram of the software modules inside a portable device embodied in the invention. The prior portable device has FM receiver module 201, audio encoder module 203, USB download module 204, Audio decoder module 206 and the main program 205. Here in this invention, we introduce the quick survey program 202 which can record, manage the user feedback information being process inside the portable device.

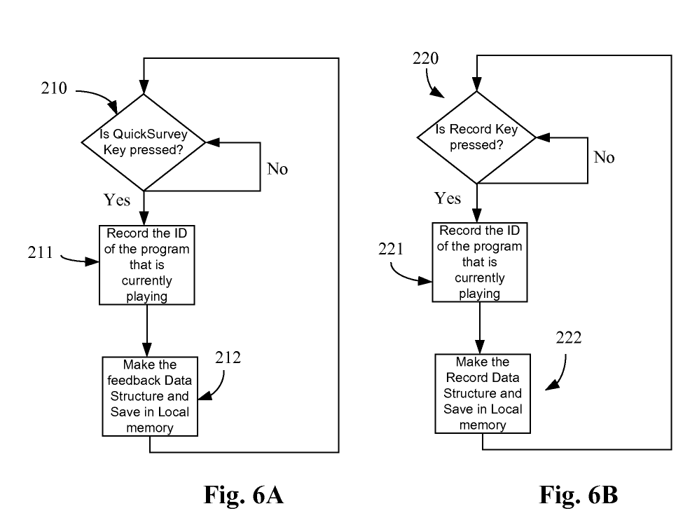

FIG. 6 is a flow chart of the operations that comprise the method of using the quick survey key and the usage of record voice mail. In step 210, software will query the status of the key press, or using interrupt mode to response for the key press. Once the Quick Survey key is pressed, as show in step 211, program will check if there is any content being played. If there is a program being played, program assume that subscribers intend to input a feedback to this content, so the content ID will be recorded together with the key subscriber pressed. In step 212, the feedback data structure is formed and saved in the local memory in portable device 40. The data will further be uploaded and sent to service provider as mentioned in FIG. 8.

The audio record function in the prior technology is simply to record and save the audio such as FM program, speech, or voice. In this invention, as show in step 220, if the record key is pressed, program will further check if there is any content being played. And if there is a content program is playing, program assuming the recorded voice or audio is a feedback record. In step 222, once the record is done, program will pack the audio information together with the ID of the content. The package data structure will be save locally and waiting for upload when the portable device is plugged in.

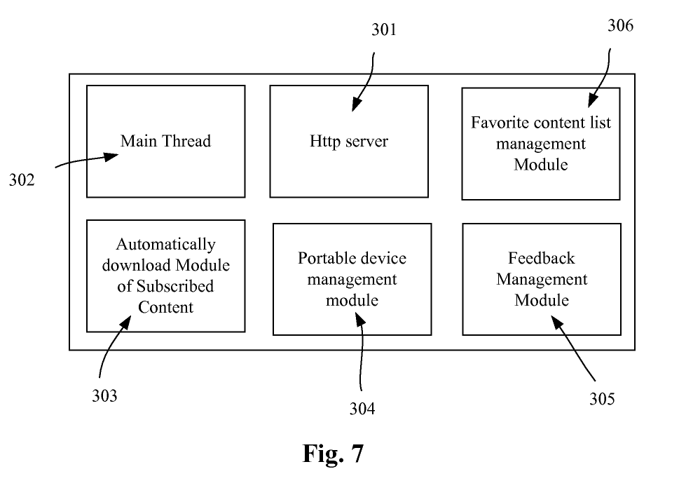

FIG. 7 is a block diagram of the software modules inside an adaptor device embodied in the invention. The program in the adaptor device consists of http server 301, Favorite content list management module 306, content download module 303, portable device management module 304, feedback management module 305, and a main program 302.

FIG. 8 is a flow chart of the operations that comprise the method when the portable device is connected with adaptor device. Step 301 is to check if there is a portable device plugged in. If it does, step 311 further checks if there is any content need to update. If answer is Yes, step 312 will download the new content from the content server and save into portable devices. After the downloading is finished, program will go to step 313 and check if there is any feedback data needs to be uploaded. If there is, in step 314, the data will be transferred from portable device to adaptor device, and adaptor device will further transfer the data up to the management server 11. Depends on which program the upload data is for, management server 11 will dispatch the data to content servers 12 or itself.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

We claim:

1. A method for providing feedback for a portable media playback device, wherein said portable media playback device, comprising the steps of:
providing feedback interfacing software to the media playback device;
downloading one or more episodes and one or more feedback questions associated with each of the episodes to the media playback device when the media playback device is docked;
playing the feedback questions associated with a episode when said episode is being playback on the media playback device;
recording subscriber feedback data associated with the feedback questions on the media playback device; and
retrieving feedback data from the media playback device when the media playback device is docked and sending the retrieved feedback data to a first designated server.

2. The method of claim 1 wherein the episodes are provided to the media playback device is automatically retrieved and provided to the media playback device when the media playback device is docked.

3. The method of claim 2 wherein the episodes are automatically retrieved in accordance with a content list.

4. The method of claim 3 wherein the content list is stored on a second designated server.

5. The method of claim 3 wherein said content list may be modified by one or more subscribers.

6. The method of claim 1 wherein a button on the media playback device is associated with the recording step in recording subscriber feedback data, wherein upon pressing the button the subscriber feedback data can be recorded and associated with the respective episode.

7. The method of claim 3 wherein the second designated server surveys the internet for the episodes in the content list that has been updated to generate an updated episode list.

8. The method of claim 7 wherein the updated episode list is communicated with the docking station and the docking station retrieves the updated episode and provided to the media playback device.
